(19) United States
(12) Patent Application Publication
(10) Pub. No.: US 2011/0274256 A1
(43) Pub. Date: Nov. 10, 2011

(54) VOICEMAIL MODULE

(75) Inventors: Artur TYLOCH, Warsaw (PL); Istvan NAGY, Budapest (HU); Dmytro ZAYATS, Arlington Heights, IL (US); Attila INCZE, Budapest (HU); Naheed VORA, Santa Clara, CA (US); Maarten ECTORS, Madrid (ES)

(73) Assignee: NOKIA SIEMENS NETWORKS OY, Espoo (FI)

(21) Appl. No.: 12/776,848

(22) Filed: May 10, 2010

(51) Int. Cl. H04M 1/64

(52) U.S. Cl. 379/88.22

(57) ABSTRACT

A voicemail module is described, which module is intended to be incorporated into a voicemail system of one or more end users. The voicemail module includes a plurality of settings, some of which may be provided by the developer and some of which may be provided by the end user. For at least some of the settings that are provided by the developer, a flag or some other mechanism is provided for indicating whether the developer allows the end user to modify the setting. Thus, a flexible voicemail module is provided that enables the developer of the module to retain control of the aspects of the module that can be configured by the end user.

The present invention is directed to a voicemail application.

Voicemail applications are well known in the field of telecommunications. Voicemail applications allow an incoming call to be diverted to a voicemail program to enable the calling party to leave a message. The calling party may be diverted to voicemail, for example, because the called party is unavailable or because the called party chooses not to accept the incoming call.

Voicemail applications are typically provided by telecommunications operators. Such operators provide voicemail services for large numbers of customers. Such services cannot readily be customised by end users. Typically, a voicemail service allows an end user to record a message to be played to the calling party asking them to leave a message, but does not allow any further customisation.

Thus, existing voicemail services lack flexibility. In particular, it is difficult for developers of voicemail applications to provide voicemail applications to end users.

The present invention seeks to address at least some of the problems outlined above.

The present invention provides a method comprising: generating a voicemail module; populating one or more settings of the voicemail module; and for at least some of said settings, indicating whether an end user is allowed to modify the setting.

The said voicemail module may be adapted from an existing voicemail module. For example, a voicemail module may be obtained from a library of voicemail modules, modified, and then provided to an end user.

In some forms of the invention, each setting has a default setting indicating whether the end user is allowed to modify the setting. Furthermore, the default setting may be applied in the absence of an indication to the contrary.

The said voicemail module may be adapted to be incorporated into a voicemail system of a user, wherein said voicemail system comprises one or more voicemail modules.

Thus, a voicemail module is described, which module is intended to be incorporated into a voicemail system of one or more end users. The voicemail module includes a plurality of settings, some of which may be provided by the developer and some of which may be provided by the end user. For at least some of the settings that are provided by the developer, a flag or some other mechanism may be provided for indicating whether the developer allows the end user to modify the setting. Thus, a flexible voicemail module is provided that enables the developer of the module to retain control of the aspects of the module that can be configured by the end user.

The present invention also provides a voicemail module comprising: one or more settings; and a processor adapted to control whether an end user is allowed to modify the said setting.

The invention yet further provides a computer program comprising: code (or some other means) for generating a voicemail module; code (or some other means) for populating one or more settings of the voicemail module; and code (or some other means) for indicating whether an end user is allowed to modify at least some of said settings. The computer program may be a computer program product comprising a computer-readable medium bearing computer program code embodied therein for use with a computer.

Exemplary embodiments of the invention are described below, by way of example only, with reference to the following numbered schematic drawings.

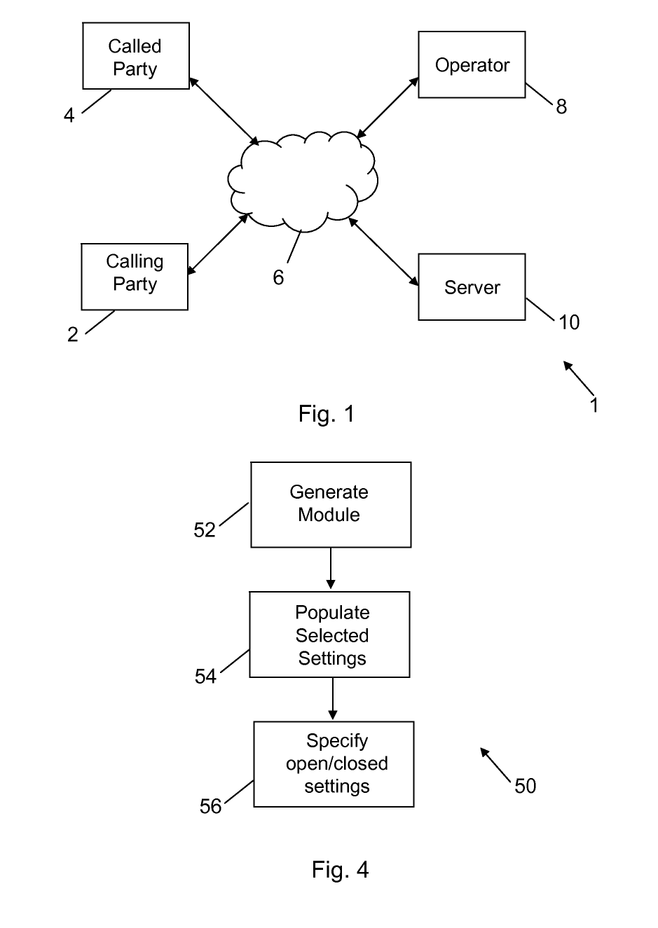

FIG. 1 is a block diagram of a system in which the present invention may be used.

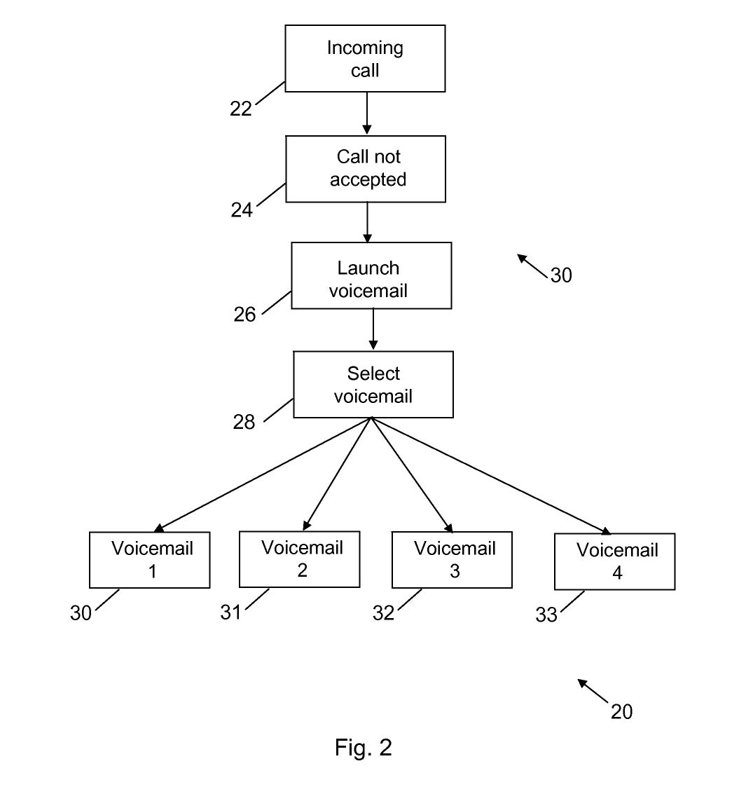

FIG. 2 is a flow chart showing an algorithm in accordance with an aspect of the present invention.

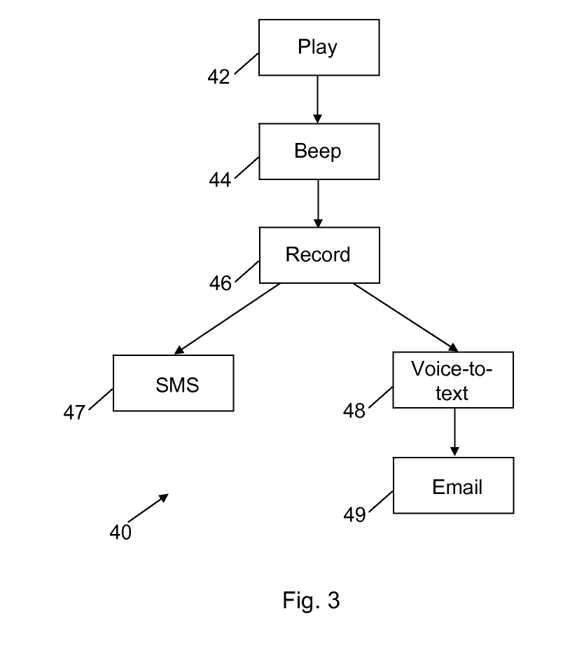

FIG. 3 is a flow chart showing an algorithm in accordance with an aspect of the present application.

FIG. 4 is a flow chart showing an algorithm in accordance with an aspect of the present invention.

FIG. 1 shows an exemplary system, indicated generally by the reference numeral 1, in which the present invention may be used. The system 1 comprises a communication device of a calling party 2, a communication device of a called party 4, a telecommunications network 6, a telecommunications operator 8 and a server 10. As described below, the server 10 provides one or more voicemail applications. The calling party 2 uses the telecommunications network 6 to attempt to call the called party 4.

The calling party 2 and/or the called party 4 may be implementing using a mobile communication device. The calling party 2 and/or the called party 4 may be implementing using a fixed-line communication device. The network 6 may be a mobile communications network and/or a fixed-line network. The operator 8 may be a mobile operator and/or a fixed-line operator.

FIG. 2 is a flow chart showing an algorithm, indicated generally by the reference numeral 20, in accordance with an aspect of the present invention. The algorithm 20 starts at step 22 where a call is made (or is attempted to be made) from the calling party 2 to the called party 4.

Next, at step 24, an indication is given that the call will not be (or is not) accepted. This may, for example, be because the called party is unavailable (perhaps because the device is switched off). Alternatively, the called party may refuse to accept the call. In any event, at step 24, the called party does not answer the call. This step usually triggers the activation of a voicemail service of the operator 8.

Next, at step 26, a voicemail application provided by the server 10 is used to replace (or possibly work alongside) the normal voicemail service provided by the operator 8.

The application 10 may monitor communications sent to and/or from the mobile communication device of the called party 4. In this way, the application 10 can determine when the voicemail service should be initiated. Typically, the operator 8 implements voicemail services by diverting calls to its own voicemail service. This functionality can be used to arrange for the diversion to be made to the voicemail service provided by the server 10 rather that to the voicemail service provided by the operator 8. In one form of the invention, the called party 4 needs to instruct the operator (in advance) to redirect voicemail services to the server 10. Thus, the server 10 may simply await an indication of the operator 8 that a voicemail application should be initiated.

In one embodiment of the invention, the application 10 is implemented using a session initiation protocol (SIP) server.

The algorithm 20 proceeds to step 28 where a service logic (provided by the application 10) determines which of a number of voicemail services available to the voicemail application 10 should be used. In the exemplary algorithm 20, a first voicemail service 30, a second voicemail service 31, a third voicemail service 32 and a fourth voicemail server 33 are provided. Of course, more or fewer than four voicemail services could be provided.

In one form of the invention, the identity of the calling party 2 and/or the identity of the called party 4 may be used to select the voicemail application that should be used. For example, different voicemail accounts may be setup for different calling parties, or different classes of calling parties. Thus, a called party's wife may be diverted to the first voicemail application 30, the called party's personal friends may be diverted to the second voicemail application 31 and the called party's work colleagues may be diverted to the third voicemail application 32. All other callers may be diverted to the fourth voicemail application 33 (which functions as a default voicemail application).

Alternatively, or in addition, to using the calling party's identity to select an appropriate voicemail application, the called party's presence status may be used. For example, if the called party's presence status is “in a meeting”, then a voicemail application relevant to that status may be selected. Such an application may indicate that the called party is temporarily unavailable, but should be available soon. If the called party's presence status is “on vacation” and the calling party is a work colleague, the selection voicemail application might suggest that the calling party contacts one of the called party's colleagues for further assistance. If the called party's presence status is “on vacation” and the calling party is a personal friend, then an appropriate voicemail application could be selected indicating that the called party is on vacation but he can be contacted at a particular hotel in cases of emergency.

Of course, other selection mechanism, making use of one or more selection criteria, could be provided. For example, the location of the calling party and/or the called party or the time of day (alone or with other criteria) could also be used for making selection decisions. The skilled person will be able to think of many suitable selection algorithms.

One of the voicemail services 30, 31, 32 and 33 may be designated as a default voicemail service (e.g. the fourth voicemail application in the first example given above). Thus, if the selection step 28 does not determine that one of the other voicemail services should be selected, then the default service is used. The default service might typically be used if one or more of the calling party 2 and the called party 4 does not have a specific voicemail application assigned to it.

FIG. 3 is a flow chart showing an algorithm, indicated generally by the reference numeral 40, in accordance with an aspect of the present application. The flow chart 40 shows an exemplary voicemail application that might be provided by the voicemail application 10.

The algorithm 40 starts at step 42, where a message is played. The message might ask the calling party to leave a message. The message played at the step 42 may be provide as an audio file. The algorithm 40 may provide a file location for the audio file and, in some forms of the invention, the called party 4 (or a third party) may be able to change the file location of the audio file in order to change the message that is played. Alternatively, or in addition, the called party or a third party may be able to modify or replace the audio file itself.

Next, at step 44, a “beep” message is played. The beep may simply be an audible beep played to the calling party to indicate that a message should now be left. As with the step 42, the step 44 may include a reference to an audio file providing the beep message. As with the message played at step 42, the beep message could be modified, or the file location for the beep message could be modified.

The algorithm 40 then moves to step 46, which is a “record” step. At step 46, a message can be left by the calling party and that message is recorded.

Once the record step has been completed, the algorithm 40 divides in two, moving to both step 47 and 48.

At step 47 of the algorithm 40, an SMS message is sent to the called party informing them that a voicemail message has been left. The SMS message sent at step 47 might provide instructions of how the called party can retrieve the message. This branch of the algorithm 40 terminates once the step 47 has been completed.

At step 48 of the algorithm 40, a voice-to-text algorithm is applied to the message recorded at the record step 46 in order to transcribe any message left by the calling party. The algorithm 40 then moves to step 49, where the message transcribed at step 48 is placed into an email message, and that email message is sent to an email account of the called party. This branch of the algorithm 40 terminates once the step 49 has been completed.

The algorithm 40 is one of many voicemail algorithms that could be implemented by the voicemail application 10.

The voicemail applications 30, 31, 32 and 33 that are provided by the voicemail application at the server 10 may be implemented in many different ways. For example, one or more of the voicemail applications might be implemented by being coded by a computer programmer. Alternatively, one or more of the voicemail applications might be purchased by an end user. In some forms of the invention, the entire voicemail application may be bought. In other forms of the invention, one or more of the voicemail applications 30, 31, 32 and 33 may be bought, with other applications being provided or obtained in some other way. Thus, the present invention can provide a great deal of flexibility.

Voicemail modules, such as the voicemail services 30, 31, 32 and 33 described above, are typically generated by a developer. The developer needs to have both computer programming skills and an understanding of telecommunications infrastructure (typically mobile telecommunications infrastructure) in order to develop such modules. Accordingly, a well designed voicemail module can be valuable and is a commodity that users may be willing to pay for.

As described above, a voicemail module may have many settings, some of which an end user might want to configure.

FIG. 4 is a flow chart showing an algorithm, indicated generally by the reference numeral 50, in accordance with an aspect of the present invention. The algorithm 50 starts at step 52, where a developer generates a voicemail module. By way of example, the developer may generate a voicemail module such as the module 40 described above. Of course, the module 40 is described by way of example only.

Next, at step 54, the developer populates selected settings of the voicemail module 50. For example, the developer may provide a message for output as part of the play step 42 of the algorithm 40.

Finally, at step 56, the developer specifies which of the settings can be modified by an end user, and which settings cannot be modified by an end user. There are many reasons why the developer of a voicemail module may wish to either provide or deny the end user access to such settings, as discussed further below.

Consider the exemplary algorithm 40 described above. The message played at step 42 and the beep audio output 44 are described above as being modifiable. However, a developer may prepare a particular voicemail module in which he does not want the message played at step 42 to be modified. For example, a company may prepare a voicemail module as part of an advertising campaign and may distribute that voicemail module freely on the Internet. The voicemail module may provide a message relevant to that campaign and the free distribution is used as a way to get the advertising message into the market. Clearly, the developer would not generally want to provide the end user with the ability to modify such a message.

After the record step 46 of the algorithm 40, the algorithm 40 provides an SMS message to the end user (at step 47) and provides an Email including a transcription of a message (at step 49). The developer may not want the user to change the underlying algorithm. However, the developer may want the user to be able to provide an SMS number for use in the step 47 and to provide an Email address for use in the step 49. Accordingly, the developer may wish to provide the end user with limited access to the settings of the SMS and Email steps 47 and 49.

In a variant of the invention, some or all of the user details such as SMS number and Email address required by a voicemail module may be provided automatically using a stored profile for the user, such that the end user does not need to provide that information. Such an arrangement increases the convenience for end users, particularly those end users that are less confident with the use of such technology.

The present invention provides a flexible mechanism to enable the development of voicemail modules. The developer of the voicemail module is able to control the access granted to end users to settings of the voicemail module. The voicemail module can therefore be adapted for different uses.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
generating a voicemail module;
populating one or more settings of the voicemail module; and
for at least some of said settings, indicating whether an end user is allowed to modify the setting.

2. A method as claimed in claim 1, wherein said voicemail module is adapted from an existing voicemail module.

3. A method as claimed in claim 1, wherein each setting has a default setting indicating whether the end user is allowed to modify the setting.

4. A method as claimed in claim 1, wherein said voicemail module is adapted to be incorporated into a voicemail system of a user, wherein said voicemail system comprises one or more voicemail modules.

5. A voicemail module comprising:
one or more settings; and
a processor adapted to control whether an end user is allowed to modify the said setting.

6. A computer program product comprising:
means for generating a voicemail module;
means for populating one or more settings of the voicemail module; and
means for indicating whether an end user is allowed to modify at least some of said settings.
